(19) United States
(12) Patent Application Publication
(10) Pub. No.: US 2006/0093455 A1
(43) Pub. Date: May 4, 2006

(54) Anchor

(76) Inventors: Juergen Wieser, Kaufering (DE); Thomas Ayrle, Obermeitingen (DE)

Correspondence Address: ABELMAN, FRAYNE & SCHWAB, 666 THIRD AVENUE, 10TH FLOOR, NEW YORK, NY, 10017, US

(21) Appl. No.: 11/255,861

(22) Filed: Oct. 20, 2005

(30) Foreign Application Priority Data
Oct. 11, 2004 (DE) 10 2004 049 489.4

(51) Int. Cl. F16B 13/06

(52) U.S. Cl. 411/71

(57) ABSTRACT

An anchor, which is designed for being anchored in a bore with a connection mass, includes a rod-shaped anchor member (11), and a sleeve member (21) having, at one of its ends, a receptacle (19) for receiving the anchor member (11), sections (29) of the extra coarse thread formed, at least regionwise, on the outer surface (32) of the sleeve member, and at least one side opening (26) formed at its end remote from the receptacle (19).

### BACKGROUND OF THE INVENTION

1. Field of the Invention

The present invention relates to an anchor designed to be anchored in a bore in a constructional component with a connection mass and having a rod-shaped anchor member and a sleeve member having at one of its end a receptacle for receiving the anchor member.

2. Description of the Prior Art

European Publication EP 11 76 321 discloses an anchor having an anchor rod that is anchored in a bore with a connection or mortar mass, and a sleeve which is screwed on the insertion end of the anchor rod and is provided with a coarse pitch outer thread. The sleeve coarse pitch outer thread projects beyond the thread of the anchor rod and serves for roughing the inner wall of the bore in order to improve the bonding between the inner wall of the bore and the mortar mass after the mortar mass hardens.

The drawback of the known anchor consists in that it can be used only with a connection mass contained in a cartridge that should be inserted in the bore before the anchor is set in. Furthermore, no load can be applied to the anchor before the mortar mass hardens.

Accordingly, an object of the present invention is an anchor in which the drawbacks of the known anchor are eliminated.

### SUMMARY OF THE INVENTION

This and other objects of the present invention, which will become apparent hereinafter, are achieved by providing an anchor having a sleeve that is provided with sections of an extra coarse thread formed, at least regionwise, on its outer surface and at least one side opening formed at its end remote from the receptacle.

The extra coarse thread sections insure that the anchor can be at least partially loaded already after completion of the setting process due to the formlocking connection of the extra coarse thread sections with the inner wall of the bore.

Furthermore, the connection mass can be introduced into the bore, after the anchor has been set in, through the hollow anchor or a hollow rod-shaped anchor member and exit into the bore through the at least one side opening formed in the sleeve member. The introduction of the connection mass into the bore can be effected, without the anchor being forced out of the bore by the exit pressure of the connection or mortar mass. This is because the anchor is secured in the bore due to the formlocking connection of the extra coarse thread sections with the bore innerwall. No cartridge with a connection or mortar mass need be introduced into the bore before anchoring of the anchor.

For obtaining of optimal furrow characteristics, it is advantageous when the extra coarse thread sections have a thread or profile height at least of 2 mm above the outer surface of the sleeve member.

Good holding values are achieved when the pitch or lead angle of the extra coarse thread sections is in a range between 35° and 85°.

A favorable geometry is obtained when the extra coarse thread sections are formed in at least two regions of the sleeve member which extend substantially parallel to a longitudinal axis of the sleeve member.

These regions can alternate with other regions extending parallel to the longitudinal axis of the sleeve member and which are provided, e.g., with projections which facilitate distribution of the connection mass and the height of which smaller than that of the extra coarse thread sections. These projections can be formed, e.g., as ribs which are wedge-shaped inclined in the setting directions.

Advantageously, the at least one side opening communicates with a slot formed in the end of the sleeve member remote from the receptacle and opening into a sleeve bore. With this arrangement, the at least one side opening or two side openings can be formed in a simple way upon casting of the sleeve member. Subsequent drilling of the opening(s) is not necessary.

It is further advantageous when there are provided, on the outer surface of the sleeve member projections extending substantially parallel to a longitudinal axis of the sleeve member and inclined in a screw-in direction of the extra coarse thread sections This prevents the sleeve member or the anchor from being screwed out after completion of the setting process.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawing show:

FIG. 1 a side view of an anchor according to the present invention with a rod-shaped anchor member screwed in a sleeve member;

FIG. 2 a longitudinal cross-sectional view of the sleeve member shown in FIG. 1 along line II-II; and

FIG. 3 a perspective view of the sleeve member.

### DETAILED DESCRIPTION OF THE PREFERRED EMBODIMENT

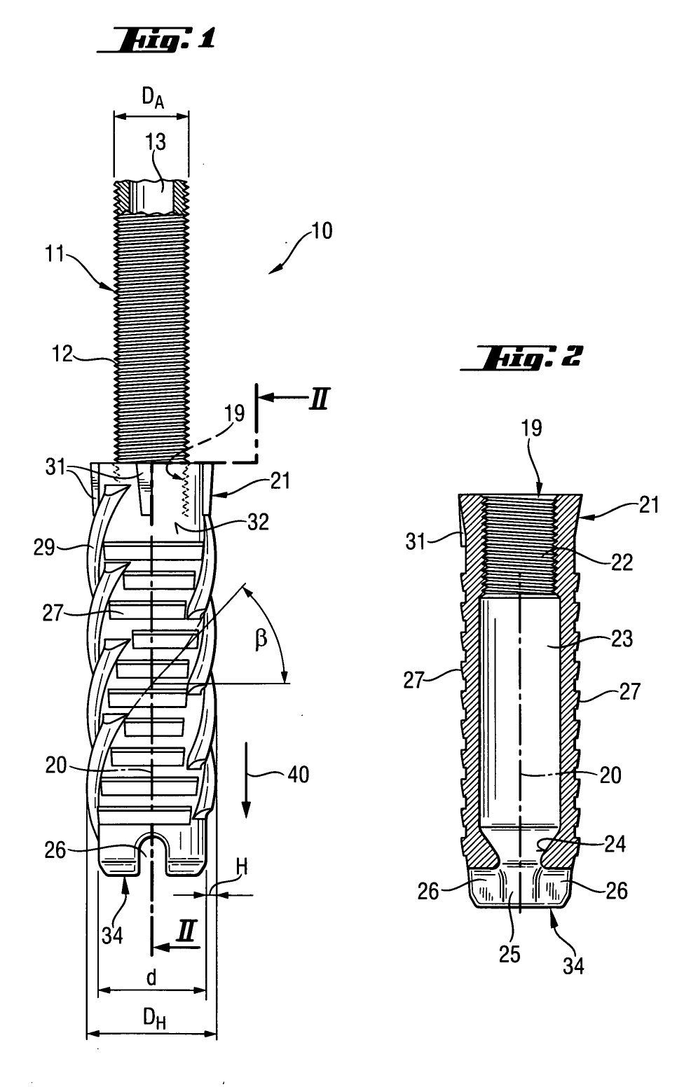

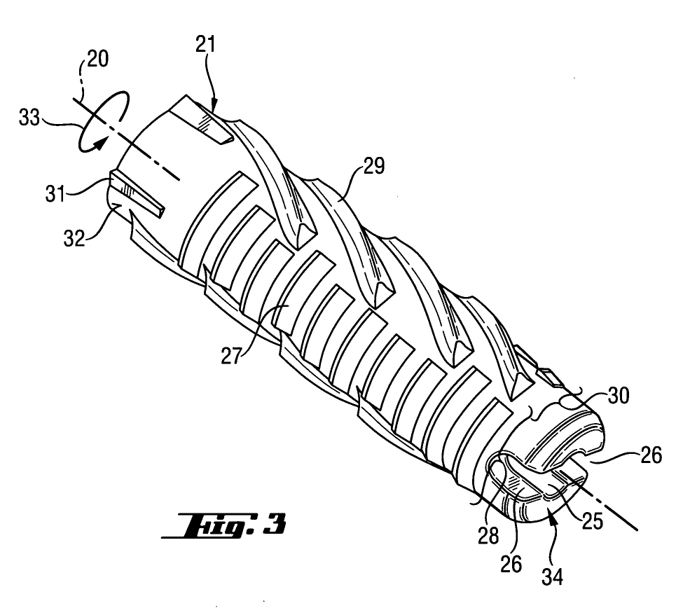

An anchor 10 according to the present invention, which is shown in FIGS. 1-3, has a rod-shaped anchor member 11 provided, at least sectionwise with a thread 12, and a sleeve member 21. At one of its ends, the sleeve member 21 has a receptacle 19 provided with an inner thread 22 that cooperates with the thread 12 of the anchor member 11 that is being screwed into the sleeve member 21, as shown in FIG. 1. The rod-shaped anchor member 11 can be screwed into the sleeve member 21 up to a stop 24 formed in bore 23 of the sleeve member 21.

Outside of the sleeve member 21, there are provided two, extending parallel to a longitudinal axis 20 of the anchor 10, regions 28 with projections 27 and which alternate with two, likewise extending substantially parallel to the longitudinal axis 20, regions 30 with sections 29 of an extra coarse thread. The projections 27 are formed as wedge-shaped ribs extending transverse to the longitudinal axis 20 and inclined in a setting direction 40 of the anchor 10.

The extra coarse thread sections 29 have a pitch with a pitch or lead angle β=50°. β is determined by an equation familiar to one skilled in the art, namely, tgβ=Ph(πd), where Ph is the pitch of the thread profile, and d—is a diameter of the sleeve member 21. The lead angle can generally vary between 35° and 85°. Any angle within this range can be considered as satisfactory. The thread height H of the extra coarse thread sections 29 above the outer surface 32 of the sleeve member 21 is preferably ≧2 mm. The flank angle of the thread ribs or of the extra coarse thread sections 29 lies preferably in a range between 25° and 90°.

When the anchor 10 is driven in the setting direction 40 with forwardly located sleeve member 21 in a bore the diameter of which is smaller than a diameter D_{H} of the sleeve member 21 between two opposite extra coarse thread sections 29 and larger than the diameter D_{A} of the rod-shaped anchor member 11, the extra coarse thread sections 29 furrow the bore wall, whereby a formlocking anchoring of the anchor 10 is achieved. Thereby, holding forces can already be obtained, even before hardening of the connection mass, which would provide for at least a partial loading of the anchor.

In the region of the receptacle 19, there are provided, on the surface 21 in screw-in direction 33 of the extra coarse thread sections 29, wedge-shaped inclined projections 31 extending parallel to the longitudinal axis 20. These projections 31 brake the setting process and prevent the sleeve member 21 from screwing-out. The projections 31 can be provided in other, than the receptacle 19, sections of the sleeve member 21.

At the front end 34 of the sleeve member 21 facing in the setting direction 40, there is provided a slot 25 opening into the bore 23 and which opens sidewise in two openings 26 in the outer surface of the sleeve member 21.

After the anchor 10 has been set, a connection mass can be brought into the space between the anchor 10 and the bore wall through a bore 13, which is formed in the anchor member 11, and the bore 23 in the sleeve member 121 which adjoins the bore 13, and further through the openings 26 at the front end of the sleeve member 21. The connection mass is introduced until it appears on the outer surface of the constructional component in which the bore, into which the anchor 10 is set in, is formed. The projections 27, which are formed as wedge-shaped ribs, improve the distribution of the connection mass and improve the connection bonding of the anchor 10. With the inventive anchor 10, introduction of a cartridge with the connection mass in a bore before setting of an anchor is not any more necessary. After the hardening of the connection mass, the anchor 10 is anchored in the bore by material bonding which insures further a required end strength, with the load application of the anchor member 11 extending out of the bore.

The sleeve member 21 can be formed, e.g., as a malleable cast iron part, with the inner thread 22, projections 27, 31, and the extra coarse thread sections 29 being formed already during the casting process. This insures a cost-effective manufacturing of the sleeve member 21.

Though the present invention was shown and described with references to the preferred embodiment, such is merely illustrative of the present invention and is not to be construed as a limitation thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. An anchor designed for being anchored in a bore with a connection mass, the anchor comprising:
a rod-shaped anchor member (11); and
a sleeve member (21) having, at one end thereof, a receptacle (10) for receiving the anchor member (11), sections (29) of an extra coarse thread formed, at least regionwise, on an outer surface (32) thereof, and at least one side opening (26) formed at an end thereof remote from the receptacle (19).

2. An anchor according to claim 1, wherein the extra coarse thread sections (29) have a thread height of at least 2 mm above the outer surface (32) of the sleeve member (21).

3. An anchor according to claim 2, wherein the extra coarse thread sections (29) have a pitch angle (β) between 35° and 85°.

4. An anchor according to claim 1, wherein the extra coarse thread sections (29) are formed in two regions (30) of the sleeve member (21) which extend substantially parallel to a longitudinal axis (20) of the sleeve member (21).

5. An anchor according to claim 1, wherein the at least one side opening (26) communicates with a slot (25) formed in the end (34) of the sleeve member (21) remote from the receptacle (19) and opening into a sleeve bore (23).

6. An anchor according to claim 1, wherein there are provided, on the outer surface (32) of the sleeve member (21), projections (31) extending substantially parallel to a longitudinal axis (20) of the sleeve member (21) and inclined in a screw-in direction (3) of the extra coarse thread sections (29).
